(19) United States
(12) Patent Application Publication
(10) Pub. No.: US 2026/0051674 A1
(43) Pub. Date: Feb. 19, 2026

(54) CONDUCTOR CONNECTION TERMINAL

(71) Applicant: WAGO Verwaltungsgesellschaft mbH, Minden (DE)

(72) Inventors: Sergej ISAAK, Stedesdorf (DE); Marcel LIEBSCHER, Bad Salzuflen (DE)

(73) Assignee: WAGO Verwaltungsgesellschaft mbH, Minden (DE)

(21) Appl. No.: 19/303,939

(22) Filed: Aug. 19, 2025

(30) Foreign Application Priority Data
Aug. 19, 2024 (DE) 20 2024 104 664.1

(51) Int. Cl. H01R 4/48

(52) U.S. Cl. CPC H01R 4/4821; H01R 4/483

(57) ABSTRACT

A conductor connection terminal, which comprises an insulating housing, a spring-force clamping connection, and an actuating lever. The spring-force clamping connection having a busbar and a clamping spring. The clamping spring including a clamping leg with a clamping edge for clamping an electrical conductor between the clamping edge and a contact section of the busbar. Further provided is a contact leg and a spring bend that connects the clamping leg to the contact leg. The actuating lever is pivotably supported in the insulating housing and configured to move the clamping leg from a closed position to an open position, in which the clamping edge is situated at a farther distance from the contact section than in the closed position, during a pivoting of the actuating lever around an actuation pivot angle.

This nonprovisional application claims priority under 35 U.S.C. § 119 (a) to German Patent Application No. 20 2024 104 664.1, which was filed in Germany on Aug. 19, 2024, and which is herein incorporated by reference.

### BACKGROUND OF THE INVENTION

### Field of the Invention

The invention relates to a conductor connection terminal, which comprises an insulating housing, a spring-force clamping connection, and an actuating lever, the spring-force clamping connection having a busbar and a clamping spring, and the clamping spring including a clamping leg with a clamping edge for clamping an electrical conductor between the clamping edge and a contact section of the busbar, a contact leg and a spring bend connecting the clamping leg to the contact leg, and the actuating lever being pivotably supported in the insulating housing, the actuating lever being configured to move the clamping leg from a closed position to an open position, in which the clamping edge is situated at a greater distance from the contact section than in the closed position, during a pivoting of the actuating lever around an actuation pivot angle.

### Description of the Background Art

DE 10 2013 101 406 B4, which corresponds to US 2016/0006176, which is incorporated herein by reference, an which discloses a conductor connection terminal of this type, which comprises an insulating housing and at least one spring-force clamping connection in the insulating housing and also comprises at least one actuating element, which is pivotably accommodated in the insulating housing and is designed to open at least one assigned spring-force clamping connection in each case. The actuating element has two side wall sections situated at a distance from each other, which at least partially dip into the insulating housing with a pivot bearing region and are connected to each other by a transverse web to form a lever arm opposite the pivot bearing region. The pivot bearing regions of the side wall sections of an actuating element situated at a distance from each other form a rotation axis, around which the actuating element is pivotably supported in the insulating housing. An assigned spring-force clamping connection is at least partially accommodated in the space between the pivot bearing regions of an actuating element. The pivot bearing regions have actuating sections, which are each designed to strike an assigned clamping spring of a spring-force clamping connection when the actuating element pivots from an open position, in which the actuating element, including its transverse web, is pivoted in the direction of the insulating housing and a clamping point formed by the spring-force clamping connection for clamping an electrical conductor is closed, into an open position, in which the actuating element, including its transverse web, is pivoted away from the insulating housing and a clamping point formed by the spring-force clamping connection for clamping an electrical conductor is opened. The actuating sections are arranged at the pivot bearing regions of the side wall sections at a shorter distance from each other than the distance between the side wall sections. The actuating sections extend in parallel to the side wall sections and are formed integrally with the side wall sections in such a way that, in each case, a guide slot is present between an actuating section and the assigned, directly adjacent side wall section. In each case, a guide web of the insulating housing dips into an assigned guide slot for the purpose of guiding the actuating element during the pivoting movement around the single fixed rotation axis in the pivot bearing region.

DE 84 24 056 U1 describes a screwless connection terminal for electrical devices, comprising a metal housing, in which a clamping spring is arranged, which has two clamping legs arranged next to each other and separated from each other by a slot. The clamping legs each have a first leg with a blocking region and a second leg with a rounded, curved region. A handle is arranged in the slot and designed to actuate the first and second legs. The handle is supported in a floating manner on the inner walls of the metal housing. In the idle position with clamping points closed, an imaginary, initial rotation axis occurs at the transition point of a side wall to the top the metal housing. During the pivoting, this contact point of the actuating lever moves on the metal housing, and the handle pivots around a moving instantaneous pole.

DE 10 2014 119 420 B3, which is incorporated herein by reference, describes a connection terminal for clamping an electrical conductor, comprising an insulating housing, which has at least one conductor insertion opening leading to a spring-force clamping connection, comprising at least one spring-force clamping connection in the insulating housing, which is formed from a busbar piece and a clamping spring, comprising at least one actuating lever, which is pivotably supported in the insulating housing by a pivot bearing and is oriented for the purpose of opening a clamping point formed by the clamping spring and the busbar piece. The pivot bearing is formed from an elongated hole having a curved pathway in the insulating housing and an elongated journal of the actuating lever, which dips into the elongated hole. The elongated journal has a length greater than its width, and the length of the elongated journal is greater in each pivot position of the actuating lever than the corresponding width of the elongated hole. The actuating lever is pivotably supported thereby around a rotation axis moving on the curved pathway of the elongated hole during the pivoting.

### SUMMARY OF THE INVENTION

It is therefore an object of the present invention is to provide an improved conductor terminal.

This object is achieved, in an example, by a conductor connection terminal of the type mentioned at the outset in that the actuating lever is pivotably supported around a first rotation axis in a first actuation pivot angle range and around a second rotation axis in a second actuation pivot angle range, which is different than the first rotation axis. The first and second rotation axes are advantageously situated at a distance from each other. The actuating lever is deflected thereby via two different rotation axes for the purpose of pivoting the actuating lever at a suitable, sufficiently large lever opening angle (i.e., actuation pivot angle). This actuation pivot angle may preferably be in the range of 70° to 90°.

The first actuation pivot angle range can be different than the second actuation pivot angle range. For example, the first actuation pivot angle range and the second actuation pivot angle range may overlap each other. It is also advantageous if the second actuation pivot angle range abuts the first actuation pivot angle range, in particular without overlapping and/or without a distance between the first actuation pivot angle range and the second actuation pivot angle range.

In the first pivot angle range, the second rotation axis may be moved into the bearing position from its idle position, in that the actuating lever is pivoted around the first rotation axis around the first pivot angle range. The clamping leg may have already been moved. However, it is also conceivable that the clamping leg is only minimally deflected or not deflected at all in the first pivot angle range. In the second pivot angle range, the clamping leg is moved into the opened position by the pivoting movement of the actuating lever around the second rotation axis situated in the bearing position for the purpose of opening the clamping point for an electrical conductor. In the opened position, an electrical conductor may thus be inserted into the spring-force clamping connection or removed without force or with little force (i.e., in a low-force manner).

With this construction, the actuating lever may operate in the region of the clamping edge of the clamping leg, so that the necessary deflecting forces may be noticeably reduced compared to the conductor connection terminal described in DE 10 2013 101 406 B4. The deflecting forces may be reduced, for example, in that the effective rotation axis is moved, so to speak, to the “back” in the conductor insertion direction during the deflection process of the clamping leg, i.e., away from and thus at a distance from the force application point of the actuating lever on the clamping spring. With the movement around the first pivot angle range, a movement of the actuating lever into an intermediate position is also achieved almost without force, from where the actuating lever may be more easily gripped by the user for the purpose of applying the actuating force.

The second rotation axis can be situated at a greater distance from the force application point of the actuating lever on the clamping leg than the first rotation axis. This results in a larger lever arm. The actuating lever may have a lever arm and a spring actuating section which interacts with the clamping leg and by means of which the clamping leg is deflected. The force application point of the actuating lever on the clamping leg is then defined by the spring actuating section. For example, the second rotation axis may be situated behind the first rotation axis in the conductor insertion direction.

The actuating lever may also be integrated hereby into the conductor connection terminal in a particularly space-saving manner. Alternatively or additionally, the first rotation axis and/or the second rotation axis may be arranged behind the clamping point in the conductor insertion direction. The necessary actuating forces for actuating the clamping spring may be minimized hereby. For example, the second rotation axis may be arranged adjacent to a rear housing wall of the insulating housing in the conductor insertion direction.

The actuating lever may be pivotably supported around exactly two rotation axes. The first rotation axis remains stationary during the pivoting around the associated first pivot angle. The second rotation axis likewise remains stationary during the pivoting around the associated second pivot angle. The first pivot angle range and the second pivot angle range may together form the entire actuation pivot angle.

The actuation pivot angle may define the maximum angular path around which the actuating lever may be pivoted. It is also possible that the actuating lever may be pivoted over a larger angle range than the actuation pivot angle, for example, in that a certain additional angle range is available after reaching the open position of the clamping leg or after reaching the closed position of the clamping leg. In this case, the actuation pivot angle relates to the angle range of the actuating lever in which the clamping leg may be moved between the open position and the closed position.

The second rotation axis may move from an idle position into a bearing position during the pivoting of the actuating lever around the first rotation axis in the first actuation pivot angle range. If the actuating lever is thus moved in the region of the first actuation pivot angle range, the second rotation axis is not stationary but moves, for example, relative to the insulating housing. The first rotation axis may be stationary during the pivoting of the actuating lever in the first actuation pivot angle range.

The first rotation axis can move from a bearing position into an idle position during the pivoting of the actuating lever around the second rotation axis in the second actuation pivot angle range. If the actuating lever is thus moved in the region of the second actuation pivot angle range, the first rotation axis is not stationary but moves, for example, relative to the insulating housing. The second rotation axis may be stationary during the pivoting of the actuating lever in the second actuation pivot angle range.

If the first or second rotation axis is in the bearing position, the actuating lever is thus supported via this particular rotation axis. If the first or second rotation axis is in the idle position, the actuating lever is not supported on this particular rotation axis.

In the transition between the first actuation pivot angle range and the second actuation pivot angle range, the first rotation axis and the second rotation axis may be in the bearing position simultaneously.

The first and second actuation pivot angle ranges together form the entire actuation pivot angle.

The actuating lever can have a spring actuating section which interacts with the clamping leg, the spring actuating section being formed on a first bearing section of the actuating lever which forms the first rotation axis. This permits a very compact, small-sized design of the actuating lever, in that the first bearing section may additionally accommodate the first spring actuating section.

The clamping leg may have at least one laterally protruding actuating lug, which abuts the spring actuating section of the actuating lever. Two actuating lugs, which are each struck by a spring actuating section of the actuating lever, preferably protrude on the two sides of the clamping leg opposite each other. The force acting upon a spring actuating section in each case is reduced thereby, and the clamping spring is actuated symmetrically.

The first bearing section can have a curved outer contour, which is supported on a first counter-bearing contour of the conductor connection terminal. The spring-force clamping connection may thus be used as a counter-bearing, like, for example, the contact leg supported on the busbar and/or the busbar. The first counter-bearing contour may generally be formed by one or multiple parts of the conductor connection terminal, for example, by the insulating housing, parts of the contact leg of the clamping spring, and/or the busbar. For example, peripheral webs of the contact leg, which are explained further below, may form the first counter-bearing contour for the first bearing sections. The first counter-bearing contour may also be formed by the rear peripheral edge of the busbar.

The first counter-bearing contour may be, for example, curved in a convex manner or be flat. The first rotation axis is guided thereby on a curved or flat path when the actuating lever pivots around the second pivot angle range, and the force applied by the clamping leg to the moving first rotation axis during the opening of the clamping leg is captured via the first counter-bearing contour, for example, by the insulating housing. This first counter-bearing contour may be formed, for example, on a cover part of a multi-part insulating housing.

The first bearing section may be guided along a first guide contour on the cover part during a pivoting movement around the second rotation axis, the first bearing section encompassing this first guide contour or engaging from below. The first guide contour may be curved in a convex manner.

The actuating lever can have a second bearing section which forms the second rotation axis and which has a curved outer contour, which is supported on a second counter-bearing contour of the conductor connection terminal. The second counter-bearing contour may be curved in a concave manner.

The insulating housing can have a two-part design, including a main housing part and a cover part closing the main housing part, the second counter-bearing contour being formed in the cover part. This permits an advantageous support of the actuating lever on the insulating housing, at least when the second rotation axis is in the bearing position. The cover part may have the mentioned first guide contour for the second rotation axis during the pivoting movement in the first pivot angle range, preferably on side wall sections of a conductor capture pocket.

The insulating housing can extend in a height direction from a housing upper side to a housing lower side, the actuating lever having an actuating section on the housing upper side, which is manually actuatable by the user, the first rotation axis being situated below the clamping point in the height direction, at least in the first actuation pivot angle range, and/or the second rotation axis being situated below the clamping point in the height direction, at least in the second actuation pivot angle range. The first and/or second pivot axis/axes is/are thus arranged relatively far down in the insulating housing when it/they is/are in the bearing position, for example on or adjacent to a lower housing wall of the insulating housing. The actuating lever may be integrated hereby into the conductor connection terminal in a particularly space-saving manner.

The actuating lever can have two side plates situated at a distance from each other, which are connected to each other by a transverse web of the actuating lever. Due to such a frame-like construction of the actuating lever, the latter may also be accommodated in the insulating housing in a particularly space-saving manner. The electrical conductor may be guided between the two side plates situated at a distance from each other.

The first rotation axis can be formed on the end region of the actuating lever opposite the transverse web in each case by a pair of first bearing sections opposite each other on the two side plates, and/or the second rotation axis is formed on the end region of the actuating lever opposite the transverse web in each case by a pair of second bearing sections opposite each other on the two side plates.

The first bearing sections can be formed on projections protruding from the side plates and facing each other, and/or the second bearing sections are formed on projections protruding from the side plates and facing each other. This permits a reliable support of the actuating lever on the first and second counter-bearings during the pivoting movement. The first rotation axis and/or the second rotation axis is/are thus formed by two bearing points situated at a distance from each other on the bearing sections opposite each other on an axis. The (virtual) first and second rotation axes formed in each case by a pair of bearing sections are preferably oriented in parallel to each other.

The plane spanned by the transverse web can be at an acute angle to the rotation axis plane spanned by the first and second rotation axes, preferably at an angle in the range of 20° to 60° and preferably 30°+10°. This makes it possible to achieve a large lever opening angle or actuation pivot angle of, for example, 70° to 90° with a good force application of the lever force onto the clamping leg.

The insulating housing can have a conductor insertion channel, which extends in the conductor insertion direction and opens to the clamping point formed by the clamping edge of the clamping leg and the contact section of the busbar for the purpose of clamping an electrical conductor. The conductor may be reliably guided to the clamping point in this way.

The insulating housing may have a conductor capture pocket, which is arranged in the alignment of the conductor insertion channel and has a base section arranged behind the busbar, viewed in the conductor insertion direction, and two side wall sections protruding from the base section at a distance from each other. The electrical conductor is thus guided by the conductor capture pocket from the clamping point, and the end region of the electrical conductor is captured in the conductor capture pocket. This prevents litz wires of a multi-wire stranded conductor from getting caught in intermediate spaces for the actuating lever. The air gaps and creepage distances are also improved. The side walls of the actuating lever may be supported on the side wall sections of the conductor capture pocket. As a result, a further improved stable pivot support of the actuating lever and a significant increase of the creepage distances may be achieved. The side plates of the actuating lever may be supported on the side wall sections of the conductor capture pocket.

The conductor capture pocket may preferably be formed by the cover part or be formed therein. The side wall sections may have a first guide contour for the second rotation axis during its movement. A certain friction may possibly be set hereby for the first actuation pivot angle range, so that the actuating lever is not arranged too loosely and “flaps back and forth.”

The contact leg can have two peripheral webs situated at a distance from each other, which laterally delimit a feed-through opening for feeding the electrical conductor, the clamping leg protruding through the feed-through opening. The clamping leg is guided laterally thereby. The clamping spring may be fastened directly to the busbar with the aid of the peripheral webs, so that a self-supporting contact insert may be easily provided. In addition, the feed-through opening makes it possible not only to feed the electrical conductor but also to feed of further elements, such as the clamping leg and/or the busbar. The peripheral webs may also form a first counter-bearing for the first bearing sections of the actuating lever.

The contact leg can have a feed-through opening, the busbar protruding into the feed-through opening.

The clamping leg may widen on both sides after the passage through the feed-through opening emanating from the spring bend, forming laterally protruding actuating lugs, the actuating lugs abutting the peripheral webs. Due to the actuating lugs, a reliable actuation of the clamping leg may take place by means of the actuating element, which may transfer the actuating force on the actuating lugs by means of its spring actuating section. The actuating lugs may be advantageously situated behind the peripheral webs in the conductor insertion direction. An easy actuation of the clamping leg is made possible hereby with little actuating force.

The clamping edge may be formed on the free end of the clamping leg. The application of force by the actuating lever may also take place in this region, in that the actuating lugs are preferably arranged on the widened end section of the clamping leg which has the clamping edge. This makes it possible to achieve the fact that significantly reduced deflection forces are necessary to open the clamping spring. The actuating lugs may be situated on the free end of the clamping leg.

The spring-force clamping connection can have a retaining element, which is designed to latch the clamping leg in the open position. The conductor connection terminal may therefore be delivered in the opened position. The clamping point thus does not have to be opened prior to the insertion of an electrical conductor.

The retaining element can be a latching arm formed integrally with the clamping spring and protruding from the contact leg. The conductor connection terminal may be implemented thereby with a small number of components, and the manufacturing and assembly complexity in production is reduced.

The spring-force clamping connection can have a releasing element with a releasing section formed by an inserted electrical conductor for the application of force, the releasing element being designed to move the retaining element and disengage the clamping leg latched on the retaining element in the open position by moving the releasing section during the application of force. The clamping point is thus able to be automatically closed once an electrical conductor has been inserted over the necessary connecting length, and the front end of the stripped conductor touches the releasing section, a releasing force being applied essentially transversely to the releasing section in the conductor insertion direction. This results in a movement of the releasing element, which interacts with the latching element of the retaining element for the purpose of disengaging the clamping leg. For this purpose, the stop for the clamping leg formed by a latching arm of the retaining element is moved away out of the latching position.

The releasing element can be a releasing arm formed integrally with the clamping spring and abutting the latching arm, the releasing section protruding from the section of the releasing arm abutting the latching arm in the direction of the plane of the busbar.

It is conceivable that multiple spring-force clamping connections can be arranged next to each other in the insulating housing with a shared busbar or separate busbars.

Two spring-force clamping connections may be arranged in the insulating housing one after the other in the conductor insertion direction with a shared busbar. A feed-through terminal is created thereby. A feed-through conductor connection terminal of this type may be designed as a single-row conductor connection terminal, in which exactly two conductor insertion openings situated opposite each other lead to a particular clamping spring, which are arranged on a shared busbar. It is conceivable in such a variant that a multi-row feed-through conductor connection terminal is implemented with a shared insulating housing, in that multiple such pairs of double spring connection terminals arranged one after the other are arranged next to each other in the insulating housing and are separated from each other by intermediate walls of the insulating housing.

An actuating lever may be pivotably supported in the insulating housing for each spring-force clamping connection. It is conceivable that all or only a portion of the spring-force clamping connections are each equipped with an actuating lever. It is optionally conceivable that an actuating lever is provided for simultaneously striking multiple spring-force clamping connections situated next to each other.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows an exemplary conductor connection terminal in a perspective view;

FIG. 2 shows the conductor connection terminal according to FIG. 1 in a side sectional view in a first actuating position;

FIG. 3 shows the conductor connection terminal according to FIG. 2 in a second actuating position;

FIG. 4 shows the conductor connection terminal according to FIG. 2 in a third actuating position;

FIG. 5 shows an actuating lever in a perspective view;

FIG. 6 shows the actuating lever according to FIG. 5 in a side view;

FIG. 7 shows a further example a conductor connection terminal in a side sectional view in the second actuating position;

FIG. 8 shows the conductor connection terminal according to FIG. 7 in the third actuating position;

FIG. 9 shows the conductor connection terminal according to FIG. 7 in a fourth actuating position;

FIG. 10 shows a clamping spring in a perspective view the closed position;

FIG. 11 shows the clamping spring according to FIG. 10 in a side view;

FIG. 12 shows the clamping spring according to FIG. 10 in a side view in the open position;

FIG. 13 shows spring-force clamping connections of the conductor connection terminal according to FIG. 7 in a perspective view;

FIG. 14 shows a spring-force clamping connection of the conductor connection terminal according to FIG. 2 in a perspective view;

FIG. 15 shows a clamping spring in an example according to the design in FIG. 2 in a perspective view,

FIG. 16 shows the clamping spring according to FIG. 15 in a side view;

FIG. 17 shows an example of a conductor connection terminal in a perspective view;

FIG. 18 shows the conductor connection terminal according to FIG. 17 in a side sectional view;

FIG. 19 shows a busbar of the conductor connection terminal according to FIG. 17;

FIG. 20 shows an example of an actuating lever in a perspective view;

FIG. 21 shows the actuating lever according to FIG. 20 in a side sectional view;

FIG. 22 shows a spring-force clamping connection, including the actuating lever, in a side view in different actuation states;

FIG. 23 shows a cover part in a perspective view; and

FIG. 24 shows a cover part, including an actuating lever, in a perspective view.

### DETAILED DESCRIPTION

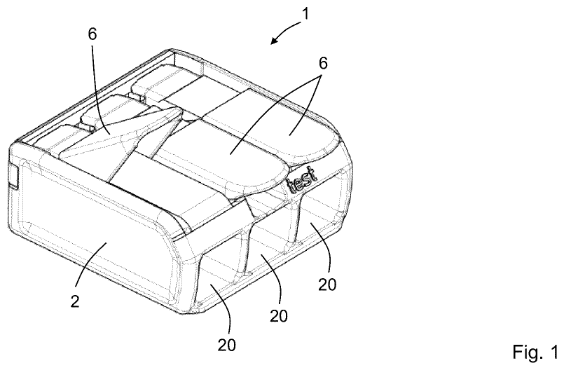

FIG. 1 shows a conductor connection terminal 1, which comprises an insulating housing 2. Conductor connection terminal 1 in the example is designed as a multipole conductor connection terminal. Accordingly, conductor connection terminal 1 has multiple conductor insertion channels 20 in insulating housing 2, through which an electrical conductor to be clamped may be inserted in each case. Multiple spring-force clamping connections are arranged in insulating housing 2, a spring-force clamping connection being assigned to each conductor insertion channel 20. Conductor connection terminal 1 has a pivotable actuating lever 6 for actuating the clamping spring of each spring-force clamping connection.

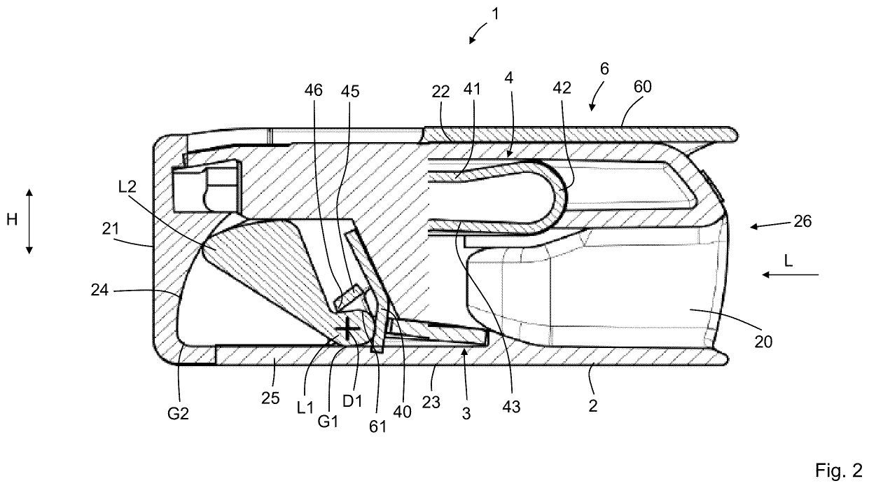

FIG. 2 shows a side sectional view of conductor connection terminal 1 according to FIG. 1 in offset planes of intersection. Insulating housing 2 extends in a height direction H from a housing upper side 22, which may be formed by an upper housing wall, to a housing lower side 23, which may be formed by a lower housing wall. Insulating housing 2 has conductor insertion channels 20 on a conductor insertion side 26, which are used to insert an electrical conductor in a conductor insertion direction L. On the end facing away from conductor insertion side 26, insulating housing 2 has a rear housing wall, which in this example is designed as part of a rear cover part 21, which may close an opening of a main housing part 25. Conductor insertion channels 20 may be situated in main housing part 25.

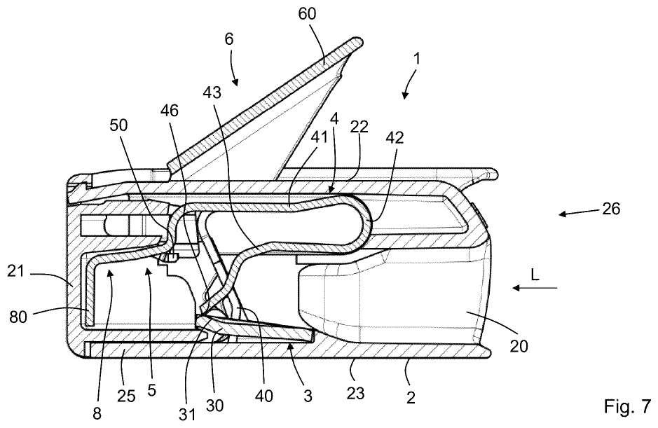

It is apparent that the spring-force clamping connection arranged in insulating housing 2 includes a clamping spring 4 and a busbar 3. Busbar 3 has a contact section 30. Contact section 30 is used to electrically contact a connected electrical conductor. Clamping spring 4 has a contact leg 41, which is fastened to busbar 3 by means of peripheral webs 40 of contact leg 41. Peripheral webs 40 may be formed as part of contact leg 41. Clamping spring 4 has a spring bend 42, which abuts contact leg 41, and a clamping leg 43, which abuts spring bend 42 and is used to clamp an electrical conductor to contact section 30 at a clamping point 31, which is apparent, for example, in FIG. 7. Clamping leg 43 ends at the free end with a clamping edge 46. Clamping leg 43 also has at least one actuating lug 45 in the region of the free end.

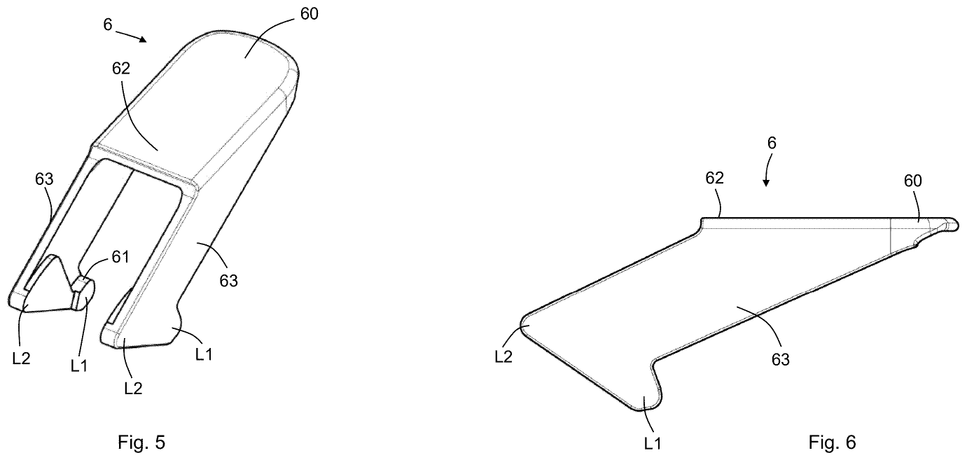

For the purpose of actuating clamping spring 4, i.e., to deflect clamping leg 43 from the clamping position illustrated in FIG. 2 into an open position, clamping lever 6 is provided, which is illustrated with further details in FIGS. 5, 6. Actuating lever 6 has a manual actuating section 60, which protrudes from insulating housing 2. Actuating lever 6 may be gripped on the manual actuating section 60 by the user and pivoted. Actuating lever 6 extends into insulating housing 2 via side plates 63. A spring actuating section 61 is situated on each of side plates 63 for applying a force to a particular actuating lug 45.

In the unactuated state of actuating lever 6, as illustrated in FIG. 2, the clamping leg is in the closed position. In this state, actuating lever 6 is pivotably around a first rotation axis D1 in a first actuation pivot angle range. Actuating lever 6 has a first bearing section L1, with the aid of which it is supported on a first counter-bearing contour G1 at least as long as it is in the first actuation pivot angle range.

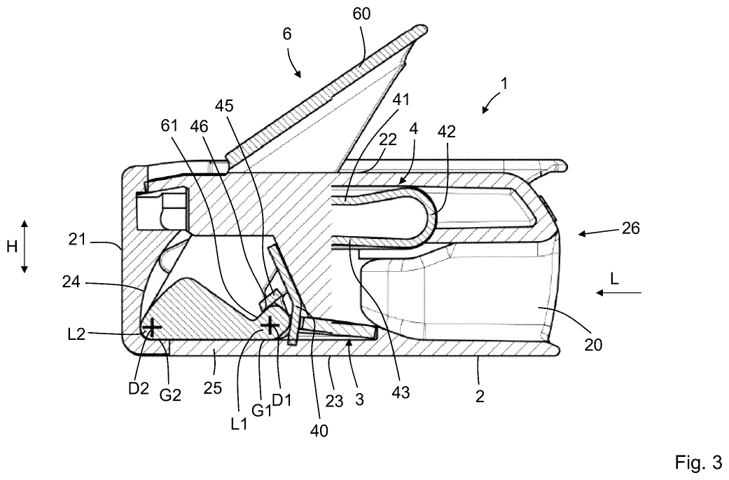

If actuating lever 6 is now pivoted, it eventually reaches the end of first actuation pivot angle range, as illustrated in FIG. 3. In this state, the rotation axis of actuating lever 6 now changes from first rotation axis D1 to a second rotation axis D2 when actuating lever 6 continues to be pivoted. It is apparent in FIG. 3 that, in this actuating state, clamping leg 43 is not yet deflected out of the closed position with the aid of spring actuating section 61 and actuating lug 45, or at least it is not essentially deflected.

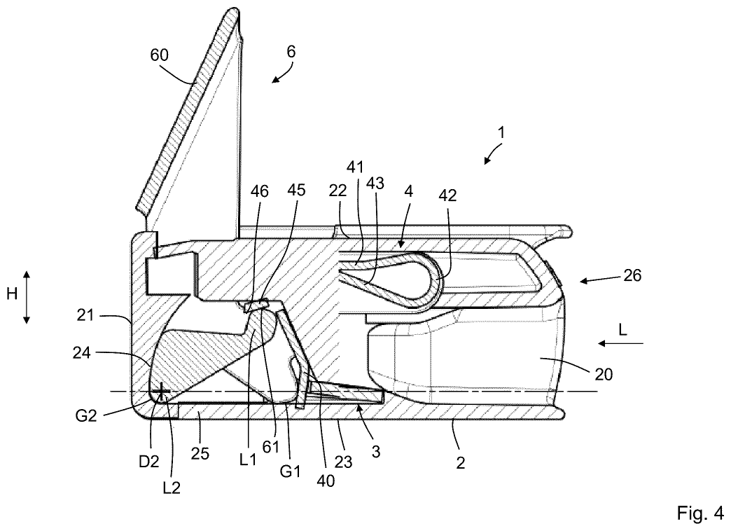

If actuating lever 6 now continues to be pivoted, as illustrated in FIG. 4, this pivoting movement takes place in the second actuation pivot angle range, in which second rotation axis D2 is effective. In this state, actuating lever 6 is supported on a second counter-bearing contour G2 via a second bearing section L2, which is situated at a distance from first bearing section L1. As shown in FIG. 4, clamping leg 43 is now deflected into the open position, i.e., it is moved away from contact section 30 of busbar 3. The clamping point may be opened in this way, so that a clamped electrical conductor may be removed, or an electrical conductor to be clamped may be easily inserted.

It is also apparent that insulating housing 2 is provided with a two-part design, including a main housing part 25 and a cover part 21, which closes main housing part 25. Cover part 21 may be designed, for example, as the rear housing part, which is arranged on the rear housing side in conductor insertion direction L. Second counter-bearing contour G2 may be formed on this cover part 21. In addition, a concave second guide contour 24 may be formed on cover part 21, by means of which actuating lever 6, including its second bearing section, L2, is guided during the movement of actuating lever 6 in the first actuation pivot angle range.

FIGS. 5 and 6 illustrate an advantageous construction of actuating lever 6. Actuating lever 6 has two side plates 63 situated at a distance from each other, which are connected to each other by a transverse web 62. Side plates 63 extend away from transverse web 62, so that a U shape is formed. In this region, side plates 63 are not connected to each other, i.e., a free space is present there. Transverse web 62 forms manual actuating section 60 on an end situated at a distance from bearing sections L1, L2. It is apparent that first bearing sections L1 and second bearing sections L2, which each face each other, are formed on the two side plates 63 at the end region of actuating lever 6 opposite transverse web 62, for example in the form of projections protruding from side plates 63 and facing each other. Spring actuating section 61 is also situated in the region of first bearing section L1 for the purpose of striking actuating lug 45 of clamping leg 43.

An example of conductor connection terminal 1 is explained on the basis of FIGS. 7 through 9, which includes a retaining element 5 for holding clamping leg 43 in the open position. A releasing element 8 is also present for releasing clamping leg 43 out of this open position held on retaining element 5, as explained below.

It is apparent in FIGS. 7 through 9 that contact leg 41 not only has peripheral webs 40 on the side facing away from spring bend 42, but retaining element 5 additionally protrudes there, which may be formed as a single piece with contact leg 41. Retaining element 5 is used to hold clamping leg 43 in the open position. Retaining element 5 has at least one second latching element 50. A first latching element is formed on clamping leg 43 by clamping edge 46 or by an additional element.

Retaining element 5 continues to extend in conductor insertion direction L to releasing element 8, which transitions into a section at an angle with respect to retaining element 5, extends transversely to conductor insertion direction L, and forms releasing section 80 of releasing element 8.

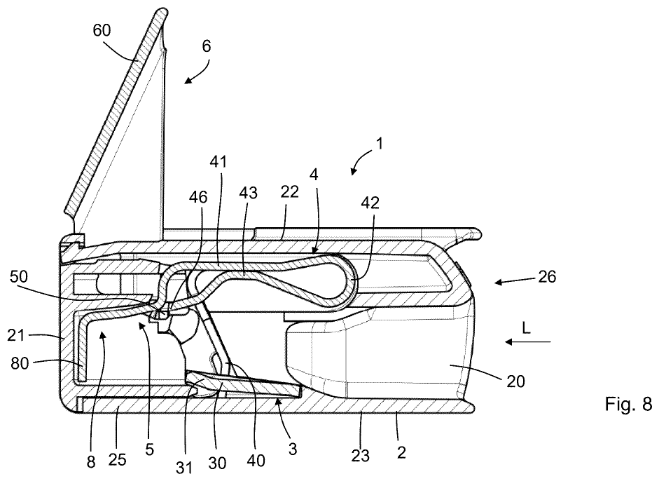

FIG. 7 initially shows conductor connection terminal 1 in the second actuation position, comparable to FIG. 3. If actuating lever 6 now continues to be pivoted, as illustrated in FIG. 8, clamping leg 43 is pivoted away from contact section 30, as explained above. FIG. 8 shows conductor connection terminal 1 in the third actuation position, comparable to FIG. 4.

Unlike FIG. 4, in the example to FIG. 8, clamping leg 43 is now latched on second latching element 50 of retaining element 5 with its clamping edge 46 or a separate latching element and is held in the open position hereby. If actuating lever 6 is pivoted back into the initial position, as illustrated in FIG. 2, clamping leg 43 remains in this latched open position.

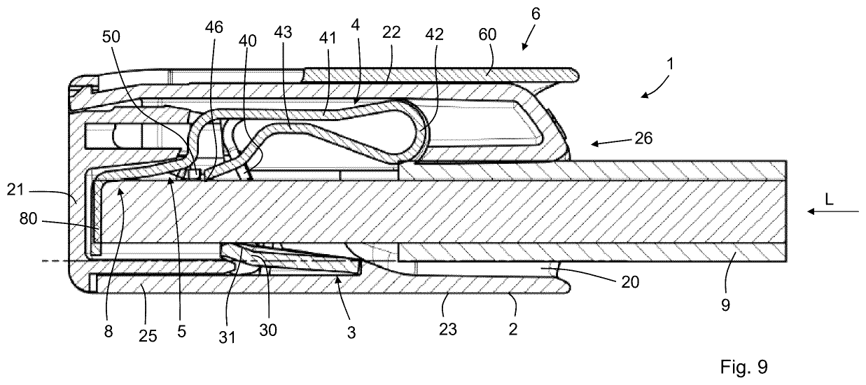

If an electrical conductor 9 is inserted through conductor insertion channel 20 into insulating housing 2 in conductor insertion direction L, as illustrated in FIG. 9, a pressing of the end of electrical conductor 9 against releasing section 80, causes the entire structural unit made up of releasing element 8 and retaining element 5 to be deflected. Releasing section 80, together with retaining element 5 or at least second latching element 50, is moved hereby slightly to the back in conductor insertion direction L, so that clamping leg 43 may release from second latching element 50. Accordingly, clamping leg 43 may spring out and press electrical conductor 9 against contact section 30. Clamping leg 43 thus moves into the clamping position, due to the spring pretension of clamping spring 4.

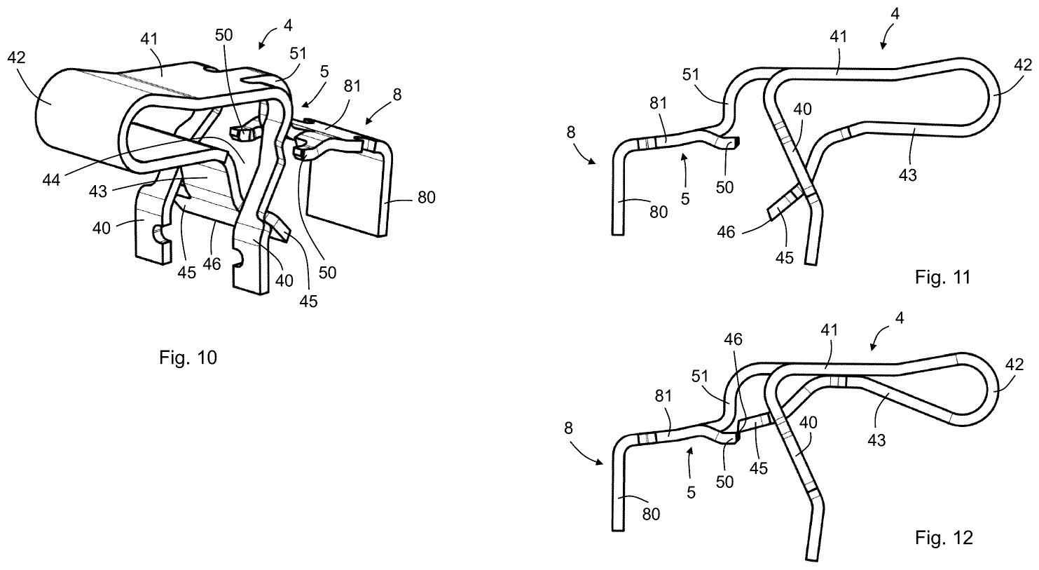

FIGS. 10 through 12 show the clamping spring of conductor connection terminal 1 according to FIGS. 7 through 9 as a single component. Clamping edge 46 may extend between actuating lugs 45. It is apparent, in particular, that retaining element 5 is formed as a single piece with clamping spring 4 and, in particular, its contact leg 41. Retaining element 5 may be a latching arm 51, which is formed integrally with clamping spring 4 and protrudes from contact leg 41. On the end of latching arm 51 facing releasing element 8, retaining element 5 has two second latching elements 50, which are formed by bent material lugs. In this way, clamping leg 43 may be latched symmetrically to retaining element 5 on both sides.

Retaining element 5 transitions as a single piece into releasing element 8. For example, releasing element 8 may be a releasing arm 81, which is formed integrally with clamping spring 4 and abuts latching arm 51. Releasing section 80 protrudes from releasing arm 81 at an angle essentially orthogonal to conductor insertion direction L. FIGS. 10 and 11 show clamping spring 4 in the relaxed state, i.e., without the latching of clamping leg 43 in the open position. FIG. 12 shows clamping spring 4 with clamping leg 43 latched on latching element 50 in the open position.

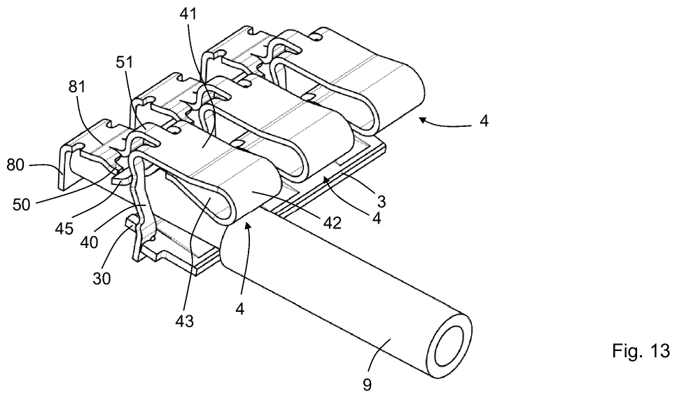

As is apparent, in particular, in FIG. 10, clamping spring 4 has two peripheral webs 40, which are situated at a distance from each other and are used to fasten clamping spring 4 on busbar 3. This is apparent in FIG. 13. FIG. 13 shows busbar 3, in this case as a continuous busbar, on which the three clamping springs 4 are fastened. Busbar 3 has a separate contact section 30 for each clamping spring 4, which extends through the intermediate space between peripheral webs 40 of a clamping spring 4. Peripheral webs 40 are connected to particular contact section 30 by a form-fitting connection. It would also be possible to design busbar 3 not as a continuous busbar, for example in that a busbar having only one contact section 30 is formed for one, multiple, or all spring-force clamping connections, i.e., the arrangement is then divided into multiple separate busbars.

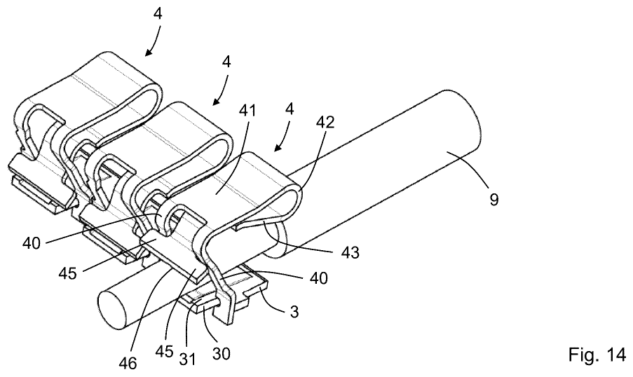

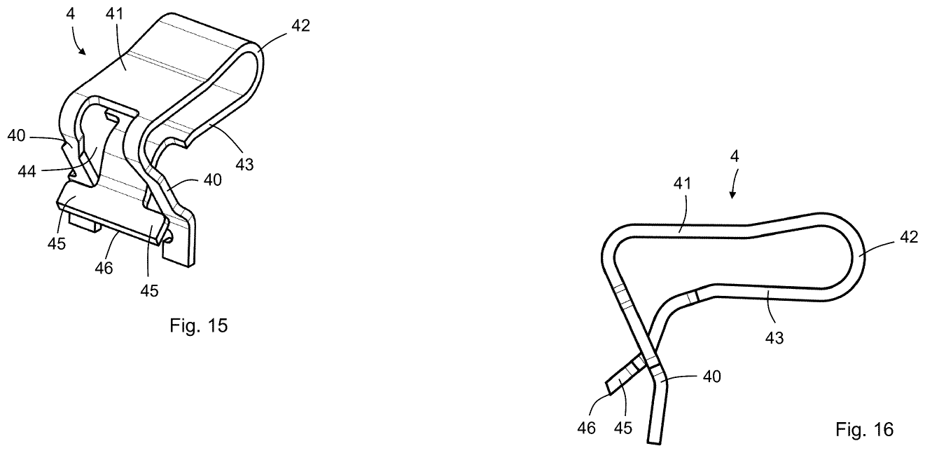

FIG. 13 shows spring-force clamping connections, in which explained retaining elements 5 and releasing elements 8 are present. FIG. 14 shows an example of comparable spring-force clamping connections, in which retaining elements 5 and releasing elements 8 are not present, as is given in the example in FIGS. 2 through 4. Accordingly, latching arm 51 in the example in FIG. 14 does not branch off of particular contact leg 41, as described on the basis of FIGS. 10 through 13. With regard to the rest of the construction and functionality, spring-force clamping connections according to FIG. 14 as well as clamping springs 4 illustrated as a single part in FIGS. 15 and 16 and used in the spring-force clamping connections according to FIG. 14 correspond to the example described on the basis of FIGS. 10 through 13.

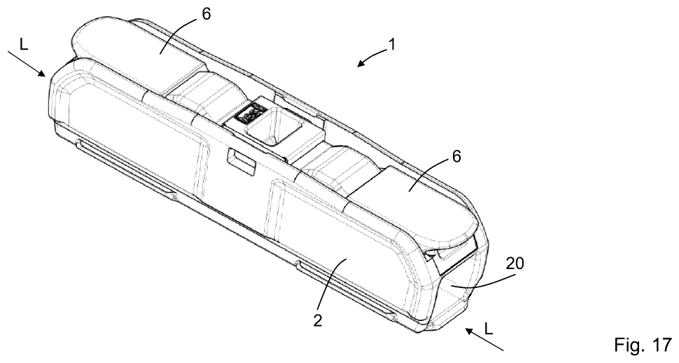

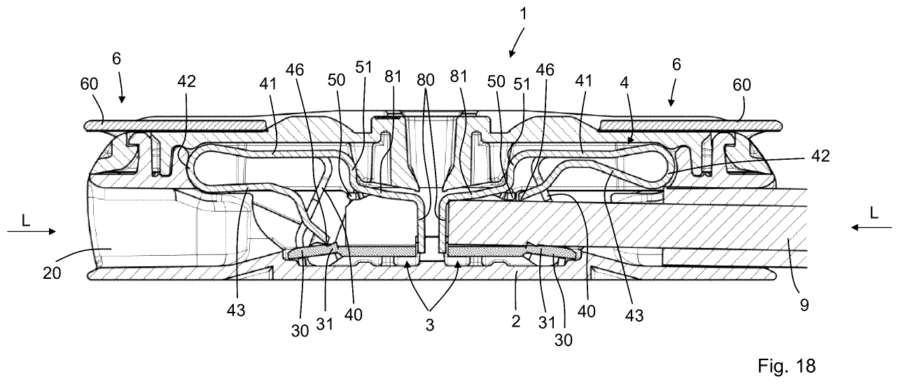

While conductor connection terminal 1 in the examples described up to now, in particular as is apparent in FIG. 1, is designed as a multipole conductor connection terminal having multiple spring-force clamping connections arranged laterally next to each other, an example of a conductor connection terminal 1, which is also provided with a multipole design, is described below on the basis of FIGS. 17 and 18, in which, however, two spring-force clamping connections are arranged one after the other in insulating housing 2 with a shared busbar 3. It is apparent in FIG. 17 that conductor connection terminal 1 has an elongated shape, in which the electrical conductors may be inserted in opposite conductor insertion directions L into particular conductor insertion channels 20 of the spring-force clamping connections arranged one after the other. As is apparent, an actuating lever 6 is again assigned to each spring-force clamping connection. Actuating levers 6 may be designed according to one of the described construction methods.

FIG. 18 shows conductor connection terminal 1 according to FIG. 17 in a side sectional view. An electrical conductor 9 is placed in the right-hand spring-force clamping connection, while no electrical conductor is present in the left-hand spring-force clamping connection. It is apparent that spring-force clamping connections may be designed according to one of the design principles described above, for example with clamping springs according to FIGS. 10 through 12 or alternatively according to FIGS. 15 through 16. FIG. 18 shows an example having clamping springs according to FIGS. 10 through 12.

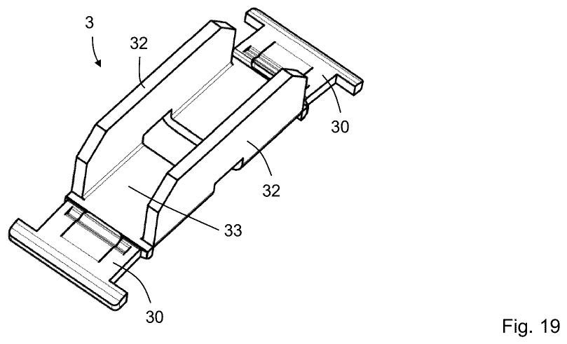

Busbar 3 is designed as a continuous busbar in the longitudinal direction or conductor insertion direction L, which electrically and mechanically connects the two spring-force clamping connections to each other. Busbar 3 is illustrated as a single component in FIG. 19. As is apparent, busbar 3 has a contact section 30 for each spring-force clamping connection at the end regions situated at a distance from each other. Contact sections 30 are connected to each other by a bridge section 33. Bridge section 33 may have, for example, two side walls 32, which protrude from the plane of contact sections 30 and by means of which busbar 3 is made mechanically more robust. Particular electrical conductor 9 may be arranged in the space between side walls 32.

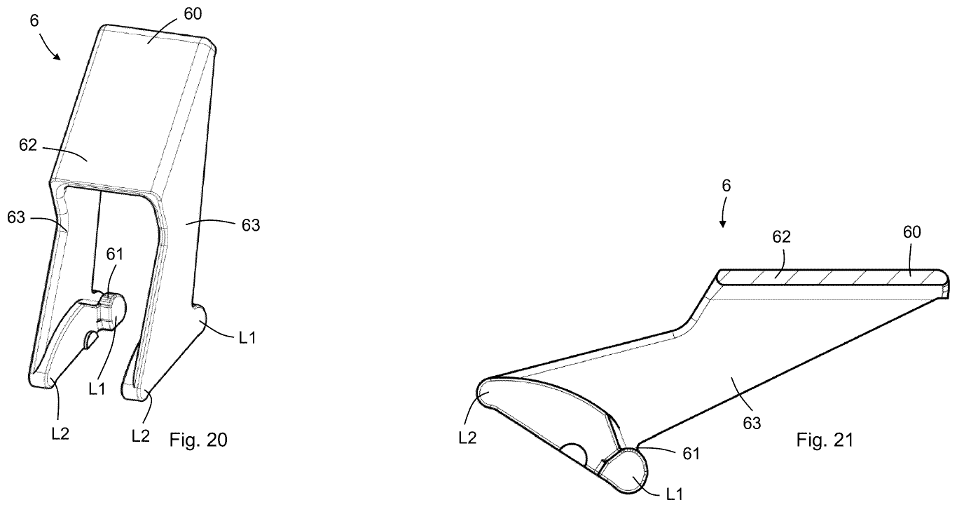

FIGS. 20 and 21 show an example of an actuating lever 6, which also has the elements already described above.

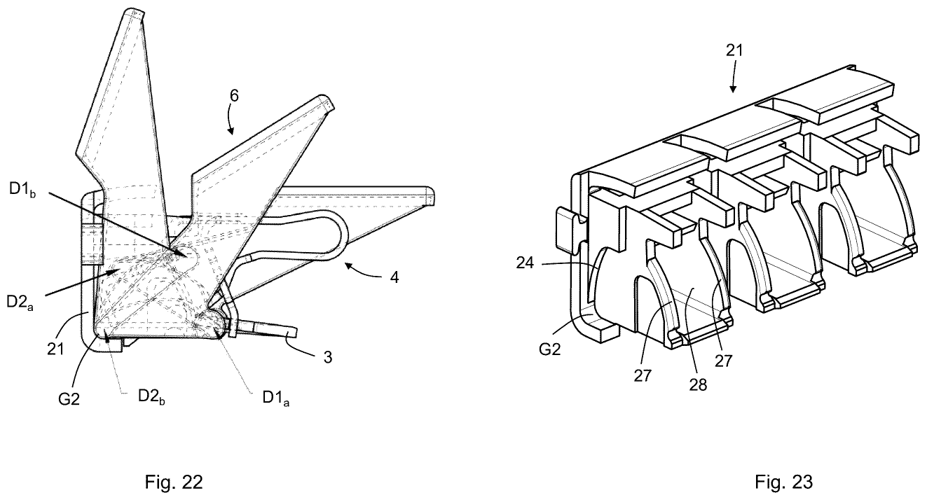

FIG. 22 shows the function of actuating lever 6 according to FIGS. 5 and 6 during the pivoting over the actuation pivot angle. First rotation axis D1 and second rotation axis D2 are designated in terms of their different modes of action depending on the pivot angle. D1 indicates the position of the first rotation axis in the first actuation pivot angle range, while D2a indicates the position of the second rotation axis in the first actuation pivot angle range. D1b indicates the position of the first rotation axis in the second actuation pivot angle range, while D2b indicates the position of the second rotation axis in the second actuation pivot angle range. This movement sequence similarly applies to the actuating lever according to FIGS. 20, 21.

FIG. 23 shows a cover part 21 for a multipole conductor connection terminal 1. The cover part has a conductor capture pocket 28 for each spring-force clamping connection of conductor connection terminal 1, which is formed between a pair of side wall sections of cover part 21. On the side facing first bearing section L1, a first guide contour 27 is formed on each of these side wall sections, on which first bearing section L1 is guided around second rotation axis D2 during a pivoting movement. First bearing section L1 encompasses this first guide contour 27 over the movement sequence.

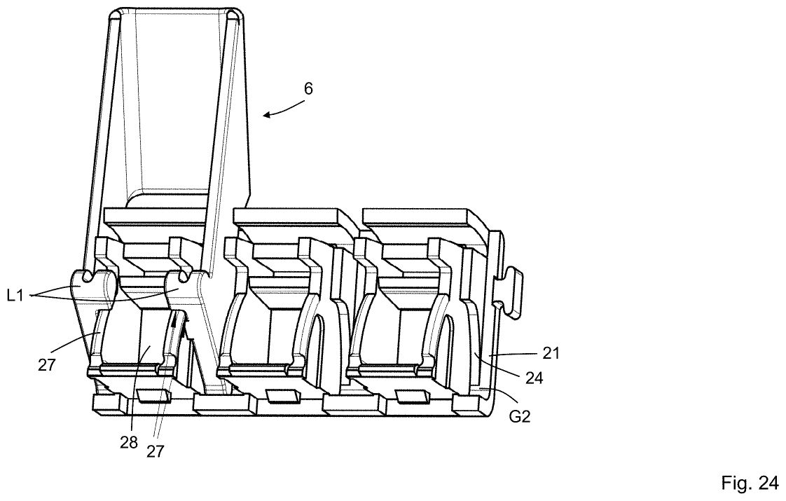

FIG. 24 shows cover part 21, as illustrated in FIG. 23, including an actuating lever 6 attached thereto, which may be designed, for example, according to FIGS. 20, 21. Lever 6 has been pivoted along first guide contour 27. As is apparent, lever 6 encompasses first guide contour 27 with its first bearing section L1, for example on a circular path.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A conductor connection terminal comprising:
an insulated housing;
a spring-force clamping connection comprising a busbar and a clamping spring, the clamping spring comprising a clamping leg with a clamping edge for clamping an electrical conductor at a clamping point between the clamping edge and a contact section of the busbar, and comprising a contact leg, and a spring bend that connect the clamping leg to the contact leg; and
an actuating lever being pivotably supported in the insulating housing, the actuating lever being configured to move the clamping leg around the actuation pivot angle from a closed position to an open position during a pivoting of the actuating lever, in which the clamping edge is arranged at a greater distance from the contact section than in the closed position,
wherein the actuating lever is rotatably supported around a first rotation axis in a first actuation pivot angle range and around a second rotation axis in a second actuation pivot angle range, which is different from the first rotation axis.

2. The conductor connection terminal according to claim 1, wherein the second rotation axis moves from an idle position into a bearing position during the pivoting of the actuating lever around the first rotation axis in the first actuation pivot angle range.

3. The conductor connection terminal according to claim 1, wherein the first rotation axis moves from a bearing position into an idle position during the pivoting of the actuating lever around the second rotation axis in the second actuation pivot angle range.

4. The conductor connection terminal according to claim 1, wherein the first and second actuation pivot angle ranges together form the entire actuation pivot angle.

5. The conductor connection terminal according to claim 1, wherein the actuating lever has a spring actuating section that interacts with the clamping leg, and wherein the spring actuating section is formed on a first bearing section of the actuating lever which forms the first rotation axis.

6. The conductor connection terminal according to claim 5, wherein the first bearing section has a curved outer contour, which is supported on a first counter-bearing contour of the conductor connection terminal.

7. The conductor connection terminal according to claim 6, wherein the first counter-bearing contour is curved in a convex manner or is flat.

8. The conductor connection terminal according to claim 1, wherein the actuating lever has a second bearing section which forms the second rotation axis and which has a curved outer contour, which is supported on a second counter-bearing contour of the conductor connection terminal.

9. The conductor connection terminal according to claim 8, wherein the second counter-bearing contour is curved in a concave manner.

10. The conductor connection terminal according to claim 8, wherein the insulating housing is provided with a two-part design, including a main housing part and a cover part closing the main housing par, and wherein the second counter-bearing contour is formed in the cover part.

11. The conductor connection terminal according to claim 1, wherein the insulating housing extends in a height direction from a housing upper side to a housing lower side, wherein the actuating lever has an actuating section on the housing upper side, which is manually actuatable by the user, the first rotation axis being arranged below the clamping point in a height direction, and wherein, at least in the first actuation pivot angle range, and/or the second rotation axis are arranged below the clamping point in the height direction, at least in the second actuation pivot angle range.

12. The conductor connection terminal according to claim 1, wherein the actuating lever has two side plates arranged at a distance from each other, which are connected to each other by a transverse web of the actuating lever.

13. The conductor connection terminal according to claim 12, wherein the first rotation axis is formed on the end region of the actuating lever opposite the transverse web in each case by a pair of first bearing sections opposite each other on the two side plates, and/or wherein the second rotation axis is formed on the end region of the actuating lever opposite the transverse web in each case by a pair of second bearing sections opposite each other on the two side plates.

14. The conductor connection terminal according to claim 13, wherein the first bearing sections are formed on projections protruding from the side plates and facing each other, and/or wherein the second bearing sections are formed on projections protruding from the side plates and face each other.

15. The conductor connection terminal according to claim 12, wherein the plane spanned by the transverse web is at an acute angle to the rotation axis plane spanned by the first and second rotation axes, or at an angle in the range of 20° to 60° or 30°+10°.

16. The conductor connection terminal according to claim 1, wherein the insulating housing has a conductor insertion channel, which extends in the conductor insertion direction and opens to the clamping point formed by the clamping edge of the clamping leg and the contact section of the busbar for the purpose of clamping an electrical conductor.

17. The conductor connection terminal according to claim 1, wherein the contact leg has two peripheral webs, which are arranged at a distance from each other and laterally delimit a through-feed opening for feeding an electrical conductor, the clamping leg protruding through the feed-through opening.

18. The conductor connection terminal according to claim 17, wherein the clamping leg widens on both sides after the passage through the feed-through opening emanating from the spring bend, forming laterally protruding actuating lugs, and wherein the actuating lugs abut the peripheral webs (40).

19. The conductor connection terminal according to claim 1, wherein the spring-force clamping connection has a retaining element, which latches the clamping leg in the open position.

20. The conductor connection terminal according to claim 19, wherein the retaining element is a latching arm, which is formed integrally with the clamping spring and protrudes from the contact leg.

21. The conductor connection terminal according to claim 19, wherein the spring-force clamping connection has a releasing element with a releasing section formed by an inserted electrical conductor for the application of force, wherein the releasing element moves the retaining element and disengages the clamping leg latched on the retaining element in the open position by moving the releasing section during the application of force.

22. The conductor connection terminal according to claim 21, wherein the releasing element is a releasing arm formed integrally with the clamping spring and abutting the latching arm, the releasing section protruding from the section of the releasing arm abutting the latching arm in a direction of the plane of the busbar.

23. The conductor connection terminal according to claim 1, wherein the second rotation axis is arranged on the clamping leg at a greater distance from the force application point of the actuating lever than the first rotation axis.
